(19) United States
(12) Patent Application Publication
(10) Pub. No.: US 2006/0199598 A1
(43) Pub. Date: Sep. 7, 2006

(54) TEXT MESSAGE BASED MOBILE PHONE SECURITY METHOD AND DEVICE

(76) Inventors: Chang-Hung Lee, Yun-Lin Hsien (TW); Shu-Yi Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/164,602

(22) Filed: Nov. 30, 2005

Related U.S. Application Data
(63) Continuation-in-part of application No. 10/605,741, filed on Oct. 22, 2003.

(51) Int. Cl. H04Q 7/20

(52) U.S. Cl. 455/466

(57) ABSTRACT

A method includes wirelessly receiving a text string at a mobile phone and parsing the text string to obtain security configuration data of the mobile phone. The method determines whether a code in the security configuration data matches a corresponding code in the mobile phone. The method further includes locking or unlocking a predetermined feature of the mobile phone when the code in the security configuration data matches the corresponding code in the mobile phone.

### CROSS REFERENCE TO RELATED APPLICATIONS

This is a continuation-in-part of application Ser. No. 10/605,741, filed Oct. 22, 2003, which is included in its entirety herein by reference.

### BACKGROUND OF THE INVENTION

1. Field of the Invention

The present invention relates to telecommunications, and more specifically, to a method and device for securing a mobile phone.

2. Description of the Prior Art

Currently, mobile (wireless) phones are undergoing much development in advanced functionality. In addition to core hardware improvements such as the development of third generation (3G) wireless phones, auxiliary functionality is also undergoing great improvement. Auxiliary functions typically include such things as: phone books, ring tones, network settings, short message services, and security features.

Configuring these auxiliary functions is conventionally performed in two ways. First, for minor adjustments, a user simply employs the mobile phone user interface. For example, such an adjustment could be adding a new phone book entry or setting the preferences for a game. Second, for major adjustments, which are usually beyond the capabilities of the phone's user interface, a PC based system is conventionally used. The user must physically connect the mobile phone to a PC by way of a connecting cable, load configuration software onto the PC, and use the configuration software to change settings in the phone. This type of adjustment could be manipulating a menu structure or uploading a ring tone. Moreover, many major adjustments can only be performed at specialized service centers by trained personnel, as they sometimes involve use of complex or proprietary software.

A popular security function of mobile phones is a personal identification number (PIN). A user has a PIN number that can be used to lock or unlock the mobile phone, that is, it is a means of configuring the security function. This is usually performed by the user manually keying in the PIN on the phone's keypad. The purpose of the PIN is that if the phone is stolen or misplaced while locked, another person cannot access the functions of the phone (e.g. to make costly long distance calls or to access private information). However, if the phone is stolen or misplaced while unlocked, there is nothing that can be done to prevent unauthorized access.

Thus, there is a need for an improved security system for mobile phones.

### SUMMARY OF THE INVENTION

It is therefore a primary objective of the invention to provide a mobile phone security method, a mobile phone, and related system that allow a user to secure a mobile phone with a text message.

According to the invention, a method includes wirelessly receiving a text string at a mobile phone and parsing the text string to obtain security configuration data of the mobile phone. The method determines whether a code in the security configuration data matches a corresponding code in the mobile phone. The method further includes locking or unlocking a predetermined feature of the mobile phone when the code in the security configuration data matches the corresponding code in the mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a mobile phone security configuration system according to the present invention.

FIG. 2 is a diagram of security configuration data according to the present invention.

FIG. 3 is a block diagram of a mobile phone according to a first embodiment of the present invention.

FIG. 4 is a flowchart illustrating a security method according to the present invention.

FIG. 5 is a block diagram of a mobile phone according to a second embodiment the present invention.

FIG. 6 is a schematic diagram of a security configuration web page according to the present invention.

### DETAILED DESCRIPTION

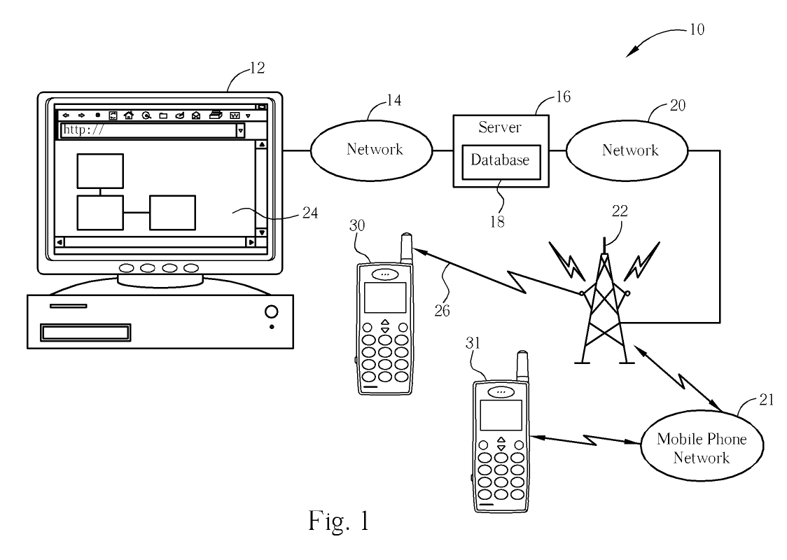

Please refer to FIG. 1 illustrating a schematic diagram of a mobile phone configuration system 10 according to the present invention. The system 10 includes a computer 12, a network 14, a server 16 storing a database 18, another network 20, a cellular base station 22, a mobile phone network 21, and a mobile phone 30. The network 14 connects the computer 12 to the server 16, and can be a wired or wireless local area intranet, or a larger network such as the Internet for example. The network 20 connects the server 16 to the base station 22. The network 20 can comprise a wired or wireless local area intranet, the Internet, and/or specialized mobile phone service provider systems (e.g. mobile services switching center, message center, etc). Moreover, the networks 14 and 20 can share components and can even be entirely the same network. The server 16 is a computer capable of communicating with the computer 12 and base station 22 via the networks 14 and 20 respectively, and further capable of storing and manipulating the database 18. The mobile phone network 21 is a network such as a GSM, GPRS, or WCDMA network, that allows mobile phones to communicate with each other. The base station 22 is for transmitting (and receiving) information to the mobile phone 30, and specifically, for transmitting a short message service (SMS) message 26 comprising configuration information to the mobile phone 30.

The computer 12 can access a web page 24 stored on the server 16. The web page 24, which will be described in detail later, allows a user of the computer 12 to manipulate a security configuration of the mobile phone 30, which can be stored in the database 18. The optional database 18 can be used to store security configurations and related web page information for a plurality of users of the present invention system 10. That is, a plurality of computers 12 can be connected to the server 16 through the network 14 to change security configurations of a plurality of mobile phones 30.

The computer 12 can send a selected security configuration through the network 14, the server 16, and the network 20 to the base station 22 for transmission to the mobile phone 30 as the SMS message 26. Equally, another mobile phone 31can be used to directly send the security configuration as the SMS message 26 across the mobile phone network 21.

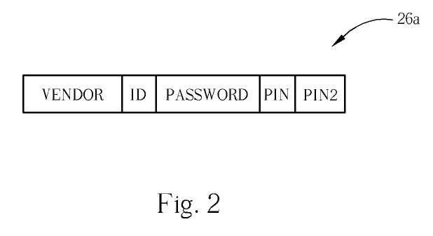

Referring to FIG. 2, an example of an SMS security configuration message 26 is illustrated. The SMS message 26a comprises VENDOR, ID, PASSWORD, PIN, and PIN2 codes as indicated. The SMS message 26a can be formed at the computer 12 and simply forwarded to the base station 22 by the server 16. The SMS message 26s can also just as easily be formed on the other mobile phone 31, by a user keying in the codes for example, and be sent by that mobile phone 31 to the mobile phone 30 across the mobile phone network 21.

The VENDOR code can include the mobile phone's vendor company identification (such as the company's name, e.g., “BENQ”), the ID code can include a unique ID number of the phone 30 (such as the phone's serial number), the PASSWORD code can be a vendor supplied master password, and the PIN and PIN2 codes can be end user created security numbers or can be provided by a security identity module (SIM) card vendor. Regardless of the exact form of the SMS message 26, it should comprise recognized text characters used in common SMS systems. For example, such messages could comprise selected characters of the ASCII character set. After the SMS message 26a is formed, the base station 22 transmits the SMS message 26a to the mobile phone 30.

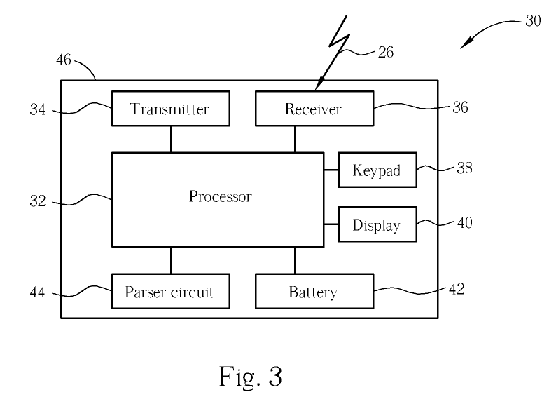

In order to successfully pass a security configuration to the mobile phone 30 via the SMS message 26 (26a), the mobile phone 30 requires a parser to interpret the SMS message. FIG. 3 illustrates a block diagram of the mobile phone 30 according to the first embodiment. The mobile phone 30 includes a processor 32, a transmitter 34, a receiver 36, an input device (keypad) 38, a display 40, a battery 42, and a parser circuit 44 all contained within a housing 46. The processor 32 is connected to all components and controls all components as is well known in the art. The transmitter 34 is for transmitting call or message information to the base station 22, and the receiver 36 is for receiving call or message information from the base station 22. The keypad 38 and display 40 constitute the user interface of the mobile phone 30. The battery 42 supplies power to all components requiring it.

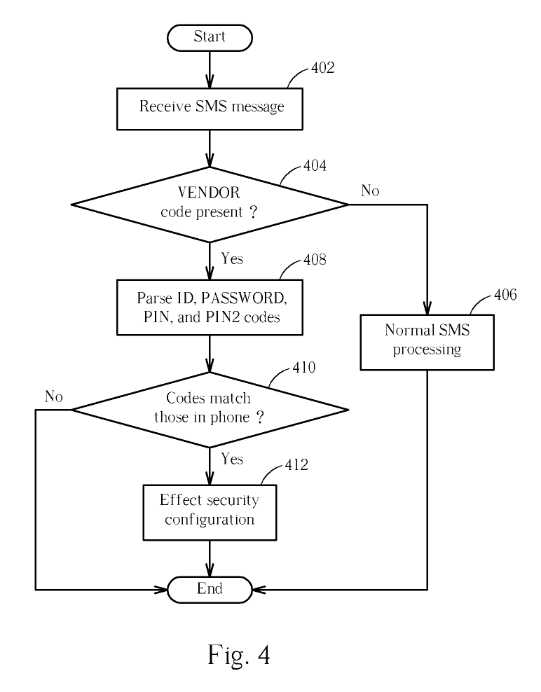

Referring to FIG. 4, the parser circuit 44 is activated by the processor 32 when an SMS message received by the receiver 36 (step 402) has the VENDOR code, which identifies the SMS message as security configuration information. That is, when a message is received at the receiver 36, the parser 44 and processor 32 parse the beginning of the SMS message to check for the VENDOR code (step 404). If the processor 32 determines that there is a VENDOR code present, meaning that security configuration information is in the remainder of the SMS message, the processor 32 instructs the parser circuit 44 to parse the remainder of the message (step 408) rather than displaying the entire message to the user on the display 40 (step 406). Then, the parser circuit 44 interprets the remainder of the message (step 408), and the processor 32 checks for a match of the ID, PASSWORD, PIN, and PIN2 codes (any or all of these codes) to those within the mobile phone 30 (step 410) and effects the security configuration if a match is detected (step 412). If the parsed codes do not match those within the phone 30, then the SMS message is ignored. The specific designs of the parser circuit 44 and processor 32 depend on exactly what format is used for the SMS message 26, and is well within the skill of one familiar with digital electronics and mobile phone architecture.

According to the present invention, the security configuration that is activated by the SMS message is a locked condition of the mobile phone 30. The locked condition is effected in the processor 32 of the mobile phone 30. In a preferred embodiment, such locking prevents calls from being placed via the mobile phone 30. In another embodiment, such locking prevents other user access to the phone (e.g. viewing a phonebook, looking up contact information, changing settings, etc). In another embodiment the locked condition can be removed by keying in the PIN code and/or PIN2 code on the mobile phone 30 itself. In still another embodiment, only another remotely sent SMS message, similar to the SMS message 26, can unlock the mobile phone 30.

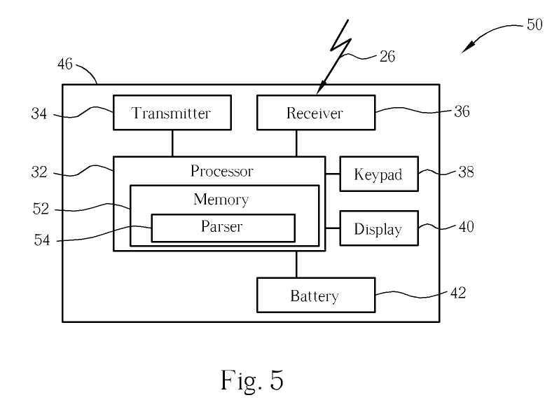

FIG. 5 illustrates a mobile phone 50 according to the second embodiment. The mobile phone 50 is identical to the mobile phone 30 except that the parser is a software parser 54 stored in a memory 52 of the processor 32. The parser 54 is code executable by the processor 32 that realizes the above functions. The memory 52 is preferably a nonvolatile memory such as a flash memory. Operation of the mobile phone 50 is the same as that of the mobile phone 30 according to the first embodiment. The specific design of the parser code 54 depends on exactly what format is used for the SMS message 26, and is well within the skill of one familiar with programming and mobile phone architecture in general.

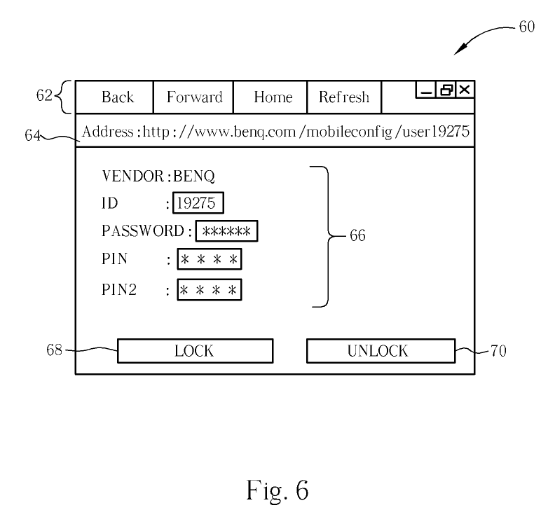

FIG. 6 is a schematic diagram of a security configuration web page 60 according to the present invention. The web page 60 is an example of the previously described web page 24. The web page 60 is stored on the server 16 and available to the user on the computer 12. The web page 60 includes common features such as browser buttons 62 and an address field 64. In addition, specific to the present invention mobile phone security configuration system, the web page 60 includes fields for entering the SMS message codes VENDOR (optional), ID, PASSWORD, PIN, and PIN2, as well as “LOCK” and “UNLOCK” buttons 68, 70 to effect the security configuration. After the user modifies the mobile phone security configuration presented on the web page 60, the user can optionally save the changes to the database 18 after effecting the security configuration of the phone 30. It is also notable that the web page 60 is formatted in a way that is easy to use on the computer 12, rather than emulating the user interface of the mobile phone 30. That is, controls are designed and presented to overcome limitations of the user interface of the phone 30. Once the SMS message codes VENDOR, ID, PASSWORD, PIN, and PIN2 are entered into the web page 60, a user can press the “LOCK” button 68 to effecting the security locking of the mobile phone 30. At this time, an SMS message 26 of predetermined format 26a is sent from the computer 12 or server 16 to the mobile phone 30 via the base station 22. Similarly, pressing the “UNLOCK” button 70 deactivates the security locking of the mobile phone 30.

On the other hand, when sending the security configuration SMS message from the other mobile phone 31, the interface used on the other mobile phone 31 is the well-known SMS message interface, and so, is not discussed further. The user need only manually key in and send the SMS message 26 (26a) from the other mobile phone 31 to the mobile phone 30 to be locked or unlocked.

In contrast to the prior art, the present invention uses established text-messaging systems to pass security configuration data, and specifically a security lock feature, to mobile phones. The present invention includes a computer for generating a text message containing security configuration data, and a parser circuit or program in a mobile phone that interprets security configuration data of effect changes on the mobile phone. Limitations in the user interface of the phone are minimized by a web page.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for effecting a security configuration of a mobile phone comprising:
wirelessly receiving a text string at a mobile phone;
parsing the text string to obtain security configuration data of the mobile phone;
determining whether a code in the security configuration data matches a corresponding code in the mobile phone; and
locking or unlocking a predetermined feature of the mobile phone when the code in the security configuration data matches the corresponding code in the mobile phone.

2. The method of claim 1 further comprising:
determining that a vendor code is present in the security configuration data before determining whether a code in the security configuration data matches a corresponding code in the mobile phone.

3. The method of claim 1 wherein the predetermined feature is a calling out feature, such that the locking prevents the mobile phone from calling out.

4. The method of claim 1 wherein the code is a mobile phone identification number, a vendor password, or a personal identification number (PIN).

5. The method of claim 1 wherein the text string is an short message service (SMS) message.

6. A mobile phone comprising:
a housing;
a processor disposed inside the housing for controlling the mobile phone, the processor controlling a locked condition of the mobile phone according to received security configuration data, wherein the locked condition restricts access to a predetermined feature of the mobile phone;
a transmitter electrically connected to the processor for transmitting signals to a base station;
a receiver electrically connected to the processor for receiving signals from the base station;
an input device electrically connected to the processor for receiving user input;
a display device electrically connected to the processor;
a power supply for providing electrical power to the mobile phone; and
a parser controlled by the processor for parsing a text string of security configuration data received at the receiver, and outputting the parsed security configuration data to the processor.

7. The mobile phone of claim 6 wherein the parser is an electronic device disposed inside the housing and electrically connected to the processor.

8. The mobile phone of claim 6 wherein the parser is a program stored in a memory of the processor and executable by the processor.

9. The mobile phone of claim 6 wherein the predetermined feature is a calling out feature, such that the locked condition prevents the mobile phone from calling out.

10. The mobile phone of claim 6 wherein the text string is an short message service (SMS) message.

11. A mobile phone security configuration system comprising:
a computer for setting security configuration data of a mobile phone;
a server connected to the computer for receiving the security configuration data from the computer; and
a base station connected to the server for receiving the security configuration data from the server and transmitting the security configuration data to the mobile phone as a text message;
wherein the mobile phone is responsive to the security configuration data and adjusts a locked condition of the mobile phone accordingly, the locked condition restricting access to a predetermined feature of the mobile phone.

12. The mobile phone security configuration system of claim 11 further comprising a web page stored on the server and accessible by the computer, the web page comprising a user interface allowing setting of the security configuration data.

13. The mobile phone security configuration system of claim 11 wherein the text message comprises a mobile phone vendor code, a mobile phone identification number, a vendor password, and at least a personal identification number (PIN).

14. The mobile phone security configuration system of claim 11 wherein the text message is an short message service (SMS) message.

15. The mobile phone security configuration system of claim 11 wherein the mobile phone comprises a parser for parsing the text message into the security configuration data of the mobile phone.

16. The mobile phone security configuration system of claim 11 wherein the predetermined feature is a calling out feature, such that the locked condition prevents the mobile phone from calling out.
